(19) United States
(12) Patent Application Publication
(10) Pub. No.: US 2012/0097030 A1
(43) Pub. Date: Apr. 26, 2012

(54) DEVICE AND METHOD FOR DRYING FUEL, IN PARTICULAR FOR A MOTOR VEHICLE

(75) Inventors: Volker Haas, Tamm (DE); Robert Barunovic, Gerlingen (DE)

(73) Assignee: ROBERT BOSCH GMBH, Stuttgart (DE)

(21) Appl. No.: 13/138,735

(22) PCT Filed: Jan. 29, 2010
(86) PCT No.: PCT/EP2010/051092

§ 371 Date: Dec. 6, 2011

(30) Foreign Application Priority Data
Mar. 27, 2009 (DE) 10 2009 001 925.1

(51) Int. Cl. F02M 37/22; B01D 53/26; B01D 53/02

(52) U.S. Cl. 95/148; 96/146; 96/112

(57) ABSTRACT

A device for drying fuel, e.g., in a motor vehicle, has a storage reservoir for a desiccant which absorbs moisture at temperatures below a regeneration temperature, and releases it again at temperatures above the regeneration temperature. Furthermore, a connection between the storage reservoir and a fuel tank storing the fuel is provided, the air situated above the fuel coming into operative connection with the desiccant via the connection. Using a heating device for heating the desiccant to a temperature above the regeneration temperature, the desiccant is able to be regenerated. The device for drying fuel enables removal of water contained in the fuel.

### BACKGROUND OF THE INVENTION

1. Field of the Invention

The present invention relates to a device and a method for drying fuel, in particular for a motor vehicle.

2. Description of Related Art

Diesel injection components make relatively high demands on the quality of the Diesel fuel. If undissolved water is present in the Diesel fuel, then these components malfunction within a relatively short period of time because of the attendant reduced lubrication ability of the Diesel fuel. Until now an attempt had been made to improve or ensure the operation also when fuels having relatively poor lubricating properties were used, by using coatings or special material pairings on the Diesel injection components. Both measures are relatively expensive.

It is also known that the corrosion of steel increases in gasoline injection system through which ethanol-containing Otto fuels are flowing. Here, too, additional corrosion-inhibiting measures are therefore required if a long service life of the components is to be achieved. Viewed overall, water in the fuel, be it Diesel fuel or ethanol-containing Otto fuel, thus leads to a marked increase in the wear rate at the components that are in contact with it.

From the published German patent application document DE 10 2005 035 782 A1, it is known to use a desiccant in the exhaust gas flow of a motor vehicle, which desiccant absorbs the water contained in the exhaust gas, or the water vapor contained in the exhaust gas, at low exhaust-gas temperatures and then releases it, invisibly, back into the ambient air at higher exhaust-gas temperatures.

### BRIEF SUMMARY OF THE INVENTION

Therefore, the present invention is based on the objective of providing a device and a method which make it possible to remove the moisture present in the fuel, especially water. At the same time, the device and the method are meant to make it possible for the drying of the fuel to take place as a regenerative process, so that the employed desiccant is able to be used again and again over a long period of time, even when a relatively small quantity is involved. In the ideal case this means that one and the same desiccant may be used for the total quantity of fuel required by an internal combustion engine during its total operating time, for instance, without the need to exchange or supplement it. In a device and a method, this objective is achieved by the features of the independent claims. The present invention is based on the principle that there are desiccants which absorb moisture, in particular water or water vapor, from the air at a temperature below a so-called regeneration temperature, and which release this moisture back to the ambient air again at temperatures above the regeneration temperature. This knowledge is combined with Henry's law, according to which the water content in a fluid (here: fuel) is a function of the moisture content of the air above the fluid, such that when the air above the fluid dries, the moisture content in the fluid decreases as well. Drying of the fuel, in particular the removal of water from the fuel, is thus brought about by drying the air situated above the fuel, using the desiccant.

In order to prevent that the moisture released by the desiccant to the ambient air flows back again in the direction of the fuel tank during the regeneration phase of the desiccant and thereby increases the water content in the fuel again, in one advantageous further development the storage reservoir has an inlet opening into which the connection discharges, and the inlet opening is sealable by an inlet valve.

It is especially preferred if the storage reservoir has an outlet opening and if the outlet opening is able to be sealed by an outlet valve. This makes it possible to release the moisture to the ambient air only during the regeneration phase and, on the other hand, prevent the inflow of ambient air, which would likewise be dried by the desiccant. As a result, the available quantity of desiccant is advantageously used solely for drying the fuel.

In one further advantageous development, the heating device is part of an exhaust-gas line of an internal combustion engine. The structural investment and thus the cost of the device are able to be reduced as a result, since a separate heating device may be dispensed with.

Furthermore, if the exhaust-gas line is situated in direct abutting contact with the storage reservoir, direct transfer of heat to the desiccant is achieved in a simple manner, which further reduces the structural investment.

In order to allow drying of the fuel even if electrical suppliers for the valves malfunction, or if other interruptions occur, and to prevent ambient air from reaching the desiccant at the same time, it is advantageous if the inlet valve is developed as automatically open valve at temperatures below the regeneration temperature, and if the outlet valve is developed as automatically closed valve at temperatures below the regeneration temperature.

In order to provide the largest possible contact area for the desiccant in the storage reservoir for the air to be dried, one advantageous further development also provides that the storage reservoir is filled only partially with the desiccant, so that free space without desiccant is provided inside the storage reservoir.

It is also advantageous if free space is provided above the fuel level inside the fuel tank. This provides a large area for the moisture exchange between the fuel and the air situated above the fuel.

To optimize the operation, in one especially preferred development of the method according to the present invention an inlet valve switched in a connection between the storage reservoir and the fuel tank is open in a first operating phase, in which the moisture is absorbed by the desiccant, while an outlet valve connecting the storage reservoir to the ambient air is closed, and in a second operating phase, in which the desiccant releases the moisture again, the inlet valve is closed and the outlet valve is open.

### BRIEF DESCRIPTION OF THE DRAWINGS

FIG. 1 shows a schematic illustration of a device for drying fuel.

### DETAILED DESCRIPTION OF THE INVENTION

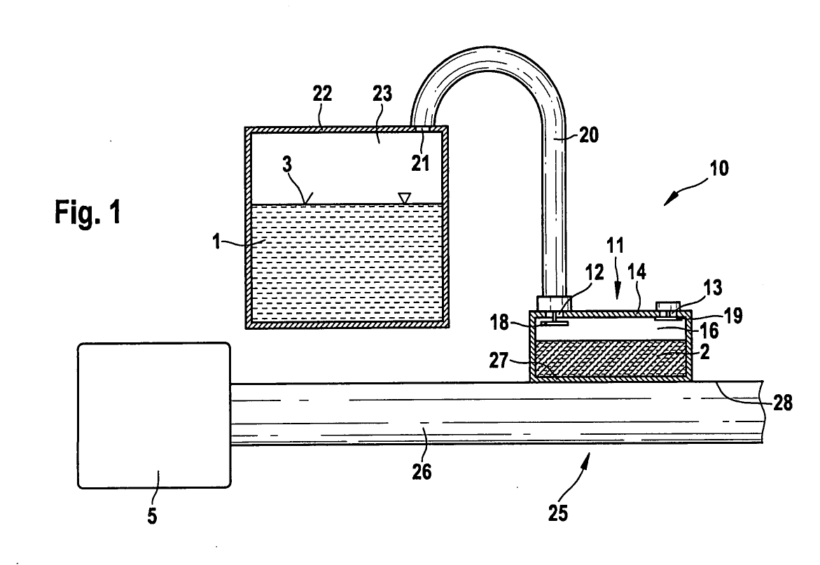

Device 10 shown in FIG. 1 is used for drying fuel 1, especially for a motor vehicle. Fuel in this case denotes Otto fuels and Diesel fuels normally used in the operation of motor vehicles in their drive motors. Fuel 1 typically contains a certain quantity of water, which lowers the lubricating properties of fuel 1 at the surfaces that come into contact with the components of the injection systems, and thus is to be removed from fuel 1 with the aid of device 10.

Device 10 has a storage reservoir 11 for a desiccant 2. Desiccant 2 is a chemical substance which is suitable for drying air, in other words, a substance that removes moisture from the air, in particular moisture in the form of water or water vapor. Silica gel, zeolite, or calcium chloride are mentioned as suitable desiccant 2 by way of example, and thus without restriction. These desiccants 2 have the ability of absorbing water or water vapor at room temperature, for example, and to release it again into the ambient air starting at a so-called regeneration temperature. Silica gel and zeolite, for example, release the previously absorbed moisture back into the ambient air at temperatures above 100 degree Celsius, whereas calcium chloride releases it only at temperatures above 250 degrees Celsius. This effect makes it possible to regenerate desiccant 2, i.e., to reuse it over and over, which is utilized in device 10.

Storage reservoir 11 has at least two openings, that is, an inlet opening 12 and an outlet opening 13. The openings are formed in an upper wall 14 of storage reservoir 11, and desiccant 2 in storage reservoir 11 does not completely fill up the space therein, but a first free space 16 remains between the surface of desiccant 2 and upper wall 14. Inlet opening 12 is able to be sealingly closed with the aid of an inlet valve 18, and outlet opening 13 is able to be sealingly closed with the aid of an outlet valve 19. Inlet valve 18 and outlet valve 19 are, for example, electrically actuable valves, the actuation taking place via a cable harness of the motor vehicle connected to a control device, in particular. While inlet valve 18 is preferably designed to be open in the currentless state, outlet valve 19 is preferably designed to be closed in the currentless state.

Inlet opening 12 is coupled to an opening 21 on a fuel tank 22 via a connection which is implemented as air-tight hose connection 20. The placement of opening 21 preferably is in an upper region of fuel tank 22, and is implemented in such a way that spilling or the entry of fuel 1 into opening 21 and hose connection 20 is prevented. Furthermore, it is especially advantageous for the drying process if a second free space 23 remains in fuel tank 22 above fuel level 3. The length of tube connection 20 according to the present invention should be as short as possible, and in addition, the largest possible cross-section of tube connection 20 should be selected because both measures facilitate the drying process, which is still to be discussed in greater detail in the following text.

Storage reservoir 11 for desiccant 2 is coupled to a heating device 25. In an especially preferred manner, it is provided that the exhaust-gas tract or an exhaust-gas line 26 of internal combustion engine 5 of the motor vehicle acts as heating device 25. As an alternative, however, it is also conceivable to equip storage reservoir 11 with a separate heating device, separate from exhaust-gas line 26, or with a heating device connected thereto. The heat transfer from exhaust-gas line 26 to storage reservoir 11, and thus to desiccant 2, takes place by convection due to the fact that storage reservoir 11 rests directly against wall 28 of exhaust-gas line 26 by way of a lower wall 27.

Device 10 operates in the following manner, it being assumed that desiccant 2 is a silica gel, for instance, which has a regeneration temperature of approximately 100 degrees Celsius. At a temperature below the regeneration temperature of the silica gel, inlet valve 18 is open while outlet valve 19 is closed. This state typically arises when parking or else during warm-up of internal combustion engine 5 because exhaust-gas line 26 has not yet heated desiccant 2 to any significant degree. Closing outlet valve 19 prevents ambient air from reaching desiccant 2. Fuel tank 22 is connected to the interior of storage reservoir 11 or to desiccant 2 via a hose connection 20 through open inlet valve 18. By way of diffusion processes, the water stored in the air above fuel 1 enters into an operative connection with desiccant 2, which withdraws the water from the air and stores it in desiccant 2. Since the water content in fuel 1 depends on the water content of the air above fuel 1 according to Henry's law, the drying of air by desiccant 2 simultaneously also removes water from fuel 1, so that fuel 1 is dried as a result. This enhances the lubrication properties of fuel 1 in the desired manner.

As soon as the temperature of desiccant 2 exceeds the regeneration temperature, which typically is the case during driving or when internal combustion engine 5 has been running for a longer period of time as a result of the heating of desiccant 2 via exhaust-gas line 26, inlet valve 18 is closed while outlet valve 19 is opened. Since the temperature is above the regeneration temperature of desiccant 2, water stored in desiccant 2 now evaporates again and may be released into the ambient air in the form of water vapor via outlet valve 19. Desiccant 2 regenerates as a result of the water release, which means that it is capable of absorbing moisture again.

It should be mentioned by way of example that for a 40 liter tank quantity of Diesel fuel, a water content of 1 vol. % corresponds to 400 gram of water. If silica gel in a quantity of 500 g is stored in storage reservoir 11, then the water quantity is able to be removed from the Diesel fuel in four absorption or regeneration cycles. If instead of silica gel, the same quantity of calcium chloride is used as desiccant 2, then the water is able to be removed in only a single cycle.

In addition, it is mentioned that it may be advantageous for accelerating the absorption of water by desiccant 2, or else for relatively long hose connections 20, to supply the air above fuel 1 to desiccant 2 in selective manner, e.g., by means of an aspiration device. This accelerates the absorption process of the water by desiccant 2 and enhances it.

Furthermore, instead of an electrically actuable inlet valve 18 and outlet valve 19, it is also possible to use valves that mechanically open or close automatically starting at certain temperatures, similar to cooling water thermostats.

1-10. (canceled)

11. A device for drying fuel in a motor vehicle, comprising:
a fuel tank storing fuel;
a storage reservoir storing a desiccant which absorbs moisture at temperatures below a regeneration temperature and releases moisture at temperatures above the regeneration temperature;
a connection between the storage reservoir and the fuel tank, wherein the air situated above the fuel comes into operative connection with the desiccant via the connection; and
a heating device heating the desiccant to a temperature above the regeneration temperature.

12. The device as recited in claim 11, wherein the storage reservoir has an inlet opening sealable by an inlet valve, and wherein the connection discharges into the inlet opening.

13. The device as recited in claim 12, wherein the storage reservoir has an outlet opening sealable by an outlet valve.

14. The device as recited in claim 13, wherein the heating device is part of an exhaust-gas line of an internal combustion engine of the motor vehicle.

15. The device as recited in claim 14, wherein the exhaust-gas line is positioned to directly abut the storage reservoir.

16. The device as recited in claim 13, wherein the inlet valve is an automatically open valve at temperatures below the regeneration temperature, and the outlet valve is an automatically closed valve at temperatures below the regeneration temperature.

17. The device as recited in claim 13, wherein the storage reservoir is filled only partially with the desiccant so that a first free space without the desiccant is formed inside the storage reservoir.

18. The device as recited in claim 17, wherein a second free space is formed inside the fuel tank, above the fuel level.

19. A method for drying fuel in a motor vehicle, comprising:
storing in a storage reservoir a desiccant which absorbs moisture at temperatures below a regeneration temperature and releases moisture at temperatures above the regeneration temperature;
providing a connection between the storage reservoir and a fuel tank storing the fuel such that the air situated above the fuel comes into operative connection with the desiccant; and
heating, using a heating device, the desiccant to a temperature above the regeneration temperature to release the moisture to the ambient air for the regeneration of the desiccant.

20. The method as recited in claim 19, wherein:
in a first operating phase, in which the moisture is absorbed by the desiccant, an inlet valve in the connection between the storage reservoir and the fuel tank is opened, and an outlet valve which connects the storage reservoir to the ambient air is closed; and
in a second operating phase, in which the desiccant releases the moisture, the inlet valve is closed and the outlet valve is open.
